(19) United States
(12) Patent Application Publication
(10) Pub. No.: US 2025/0199374 A1
(43) Pub. Date: Jun. 19, 2025

(54) TWO-DIMENSIONAL PHOTONIC INTEGRATED QUANTUM WALK CHIP AND SYSTEM

(71) Applicant: YANGTZE DELTA INDUSTRIAL INNOVATION CENTER OF QUANTUM SCIENCE AND TECHNOLOGY, Suzhou (CN)

(72) Inventors: Tian LUAN, Suzhou (CN); Yansong GAO, Suzhou (CN); Yun WANG, Suzhou (CN); Huide ZHOU, Suzhou (CN); Bo FAN, Suzhou (CN); Haifeng LI, Suzhou (CN)

(21) Appl. No.: 19/073,085

(22) Filed: Mar. 7, 2025

Related U.S. Application Data
(63) Continuation of application No. PCT/CN2024/115421, filed on Aug. 29, 2024.

(30) Foreign Application Priority Data
Oct. 30, 2023 (CN) 202311416575.7

(51) Int. Cl. G02F 1/225; G02F 1/21; G06N 10/40

(52) U.S. Cl. CPC G02F 1/2257; G02F 1/212; G06N 10/40; G02F 2201/06; G02F 2201/16

(57) ABSTRACT

The disclosure provides a two-dimensional photonic integrated quantum walk chip and system, including a two-dimensional photonic integrated quantum walk structure. The two-dimensional photonic integrated quantum walk structure includes a cladding and at least two waveguide layers stacked in a thickness direction, each of the waveguide layers including at least two waveguides, the cladding wrapping the waveguides; the waveguides are parallel to each other, and arranged in a matrix on a plane perpendicular to an extension direction of the waveguides; any one of the waveguides is coupled with the waveguides in a row direction, a column direction and a diagonal direction. By arranging multiple waveguide layers and arranging at least two waveguides in each waveguide layer, a waveguide array in matrix arrangement can be formed, and any waveguide is coupled with the waveguides in the row direction, the column direction and the diagonal direction.

### CROSS-REFERENCE TO RELATED APPLICATIONS

The application is a continuation of International Application No. PCT/CN2024/115421, with an international filing date of Aug. 29, 2024, which is based upon and claims priority to Chinese Patent Application No. 202311416575.7, filed on Oct. 30, 2023, the entire contents of all of which are incorporated herein by reference.

### TECHNICAL FIELD

The disclosure relates to a technical field of quantum information, and particularly to a two-dimensional photonic integrated quantum walk chip and a two-dimensional photonic integrated quantum walk system.

### BACKGROUND

A classical random walk is a mathematical statistical model for describing trajectories generated by a random process in a certain mathematical space, and for researching the statistical properties in a complex system. In a one-dimensional random walk, the walker moves one unit to the left or to the right with a fixed probability from the number axis position x per unit time; in a multidimensional random walk, the walker can move one unit in any direction with a fixed probability per unit time. Classical random walk has important applications in finance, physics, chemistry, biology, ecology, computer science, etc., such as simulating the fluctuation of stock price, the trajectory of molecules in liquid or gas, the searching path of foraging animals, and estimating the value of π, etc.

Quantum walk is a quantum form of the classical random walk model, which can be used to describe the motion law of quantum particles in space. During a quantum walk, a particle jumps from one position to another position with a certain probability, which is determined by the particle's wave function. Quantum walk is one of the common tools in quantum computing and is widely used in the field of quantum information, and can solve some classical problems that can not be solved by classical computers, such as graph theory, search, factorization, etc. Compared to the classical random walk, quantum walk can achieve exponential acceleration of search and computation problems.

Quantum random walk is an extension of the classical random walk in quantum mechanics, and is different from the classical random walk. Since quantum has the property of superposition state, the property of particles walking in lattice points needs to be interpreted by the statistical law of wave function from quantum mechanics. Research suggests that the demonstration of quantum random walk on quantum devices is an important way to realize quantum computing.

In summary, how to provide a two-dimensional photonic integrated quantum walk chip structure capable of realizing a two-dimensional optical quantum walk model is an urgent problem for those skilled in the art.

### SUMMARY

The disclosure provides a two-dimensional photonic integrated quantum walk chip for realizing a two-dimensional optical quantum walk model. The disclosure further provides a two-dimensional photonic integrated quantum walk system for realizing a two-dimensional optical quantum walk model.

In order to achieve the above purpose, the disclosure provides a two-dimensional photonic integrated quantum walk chip, comprising a two-dimensional photonic integrated quantum walk structure;
the two-dimensional photonic integrated quantum walk structure comprises a cladding and at least two waveguide layers stacked in a thickness direction, each of the waveguide layers comprising at least two waveguides, the cladding wrapping the waveguides;
the waveguides are parallel to each other, and arranged in a matrix on a plane perpendicular to an extension direction of the waveguides; any one of the waveguides is coupled with the waveguides in a row direction, a column direction and a diagonal direction.

Optionally, the two-dimensional photonic integrated quantum walk structure comprises at least three waveguide layers, each of the waveguide layers comprising at least three waveguides arranged at equal intervals.

Optionally, one of the waveguides coupled with the other eight waveguides is an input waveguide.

Optionally, the two-dimensional photonic integrated quantum walk chip further comprises a light source and an optical routing network, wherein the light source is connected to an input end of the optical routing network, and an output end of the optical routing network is connected to an input end of a corresponding waveguide.

Optionally, the optical routing network comprises a vertical routing network and a multilayer horizontal routing network stacked in a thickness direction, an output end of the horizontal routing network being connected to an input end of a corresponding waveguide in the waveguide layer;
an input end of the horizontal routing network is optically connected to an output end of the vertical routing network.

Optionally, the vertical routing network comprises a multi-stage Mach-Zehnder interferometer corresponding one-to-one with the horizontal routing network, and a vertical coupler disposed between adjacent horizontal routing networks;
in a vertical routing network, an input end of the vertical coupler is coupled to an output end of one of the Mach-Zehnder interferometer, and an output end of the vertical coupler is coupled to an input end of the Mach-Zehnder interferometer in another adjacent layer.

Optionally, an input end of the Mach-Zehnder interferometer disposed at the lowermost layer or the uppermost layer of the vertical routing network is optically connected to an output end of the light source.

Optionally, the vertical coupler comprises a first tapered waveguide disposed in one layer and a second tapered waveguide disposed in another adjacent layer; the first tapered waveguide is coupled to the second tapered waveguide by reverse stacked coupling.

Optionally, the horizontal routing network is provided with a multi-stage Mach-Zehnder interferometer arranged in a tree structure to form a plurality of optical paths;
the input end of the horizontal routing network is optically connected to an output end of a corresponding Mach-Zehnder interferometer in the vertical routing network.

The disclosure further provides a two-dimensional photonic integrated quantum walk system, comprising a laser emitting device, a detector array and the two-dimensional photonic integrated quantum walk chip based on any one of the above steps, wherein the laser emitting device is configured to emit laser to the two-dimensional photonic integrated quantum walk chip and the detector array is configured to obtain optical signals output by the two-dimensional photonic integrated quantum walk chip.

The disclosure provides a two-dimensional photonic integrated quantum walk chip, comprising a two-dimensional photonic integrated quantum walk structure; the two-dimensional photonic integrated quantum walk structure comprises a cladding and at least two waveguide layers stacked in a thickness direction, each of the waveguide layers comprising at least two waveguides, the cladding wrapping the waveguides; the waveguides are parallel to each other, and arranged in a matrix on a plane perpendicular to an extension direction of the waveguides; any one of the waveguides is coupled with the waveguides in a row direction, a column direction and a diagonal direction.

By arranging a plurality of waveguide layers and arranging at least two waveguides in each of the waveguide layers, a waveguide array in matrix arrangement can be formed, and any one of the waveguides is coupled with the waveguides in a row direction, a column direction and a diagonal direction, so that after one waveguide receives photons, a two-dimensional optical quantum walk model in a plane can be realized based on the coupling relationship.

The disclosure further provides a two-dimensional photonic integrated quantum walk system, which can achieve the above advantageous effects, and thus will not be described in detail herein.

### BRIEF DESCRIPTION OF THE DRAWINGS

In order to more clearly explain the technical solutions in the disclosure or the prior art, drawings required in the embodiments or the prior art will be briefly described below. Obviously, the drawings in the following description are some embodiments of the disclosure. For those skilled in the art, other drawings may be obtained from these drawings without any creative effort.

FIG. 1 is a structure schematic diagram of a front view of a two-dimensional photonic integrated quantum walk structure in a two-dimensional photonic integrated quantum walk chip based on an embodiment of the disclosure.

FIG. 2 is a structure schematic diagram of a side view of FIG. 1.

FIG. 3 is a structure schematic diagram of a two-dimensional photonic integrated quantum walk chip based on an embodiment of the disclosure.

FIG. 4 is a structure schematic diagram of a vertical routing network in FIG. 3.

FIG. 5 is a structure schematic diagram of a Mach-Zehnder interferometer in FIG. 4.

FIG. 6 is a structure schematic diagram of a top view of a vertical coupler in FIG. 4.

FIG. 7 is a structure schematic diagram of a horizontal routing network in FIG. 3.

FIG. 8 is a coupling schematic diagram of a yz cross section of a two-dimensional photonic integrated quantum walk structure based on an embodiment of the disclosure.

FIG. 9 is a structure schematic diagram of a two-dimensional photonic integrated quantum walk system based on an embodiment of the disclosure.

FIG. 10 is a schematic diagram of optical transmission of an xy cross-section of simulation results of the two-dimensional optical quantum walk chip based on an embodiment of the disclosure.

FIG. 11 is a schematic diagram of optical transmission of an xz cross-section of simulation results of the two-dimensional optical quantum walk computing chip based on an embodiment of the disclosure.

FIG. 12 shows simulation results of light field distribution of a yz cross-section and probability distribution projected in each direction after a single photon propagates 500 μm in the optical quantum walk structure in the two-dimensional photonic integrated quantum walk chip based on an embodiment of the disclosure.

FIG. 13 shows simulation results of light field distribution of a yz cross-section and probability distribution projected in each direction after a single photon propagates 1 mm in the optical quantum walk structure in the two-dimensional optical quantum walk chip based on an embodiment of the disclosure.

### LIST OF REFERENCE NUMBERS

1—waveguide; 2—cladding; 3—substrate; 4—vertical routing network; 5—horizontal routing network; 6—Mach-Zehnder interferometer; 61—50:50 beam splitter; 62—shifter phase; 63—a first interference arm; 64—a second interference arm; 7—vertical coupler; 71—a first tapered waveguide; 72—a second tapered waveguide; 8—laser emitting device; 9—detector array.

### DETAILED DESCRIPTION OF THE EMBODIMENTS

The disclosure provides a two-dimensional photonic integrated quantum walk chip. In the prior art, there is the use of a one-dimensional micro-nano waveguide and an air slot coupling array to realize a one-dimensional quantum walk model, but a one-dimensional quantum walk model can be realized.

The disclosure provides a two-dimensional photonic integrated quantum walk chip, including a two-dimensional photonic integrated quantum walk structure. The two-dimensional photonic integrated quantum walk structure includes a cladding and at least two waveguide layers stacked in a thickness direction. Each of the waveguide layers including at least two waveguides, and the cladding wrapping the waveguides. The waveguides are parallel to each other, and arranged in a matrix on a plane perpendicular to an extension direction of the waveguides. Any one of the waveguides is coupled with the waveguides in a row direction, a column direction and a diagonal direction.

By arranging a plurality of waveguide layers and arranging at least two waveguides in each of the waveguide layers, a waveguide array in matrix arrangement can be formed, and any one of the waveguides is coupled with the waveguides in a row direction, a column direction and a diagonal direction, so that after one waveguide receives photons, a two-dimensional optical quantum walk model in a plane can be realized based on the coupling relationship.

In order to enable those skilled in the art to better understand the aspects of the disclosure, the disclosure will now be described in further detail with reference to the accompanying drawings and detailed description. Obviously, the described embodiments are part of, but not all of, the embodiments of the disclosure. Based on the embodiments of the disclosure, all the other embodiments obtained by those skilled in the art without paying any creative work fall within the protection scope of the disclosure.

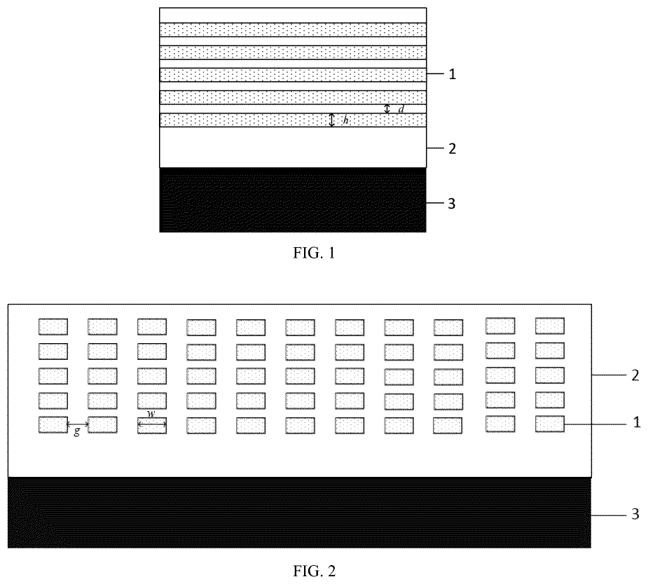

Referring to FIGS. 1 to 2, FIG. 1 is a structure schematic diagram of a front view of a two-dimensional photonic integrated quantum walk structure in a two-dimensional photonic integrated quantum walk chip based on an embodiment of the disclosure; and FIG. 2 is a structure schematic diagram of a side view of FIG. 1.

Referring to FIGS. 1 to 2, in an embodiment of the disclosure, a two-dimensional photonic integrated quantum walk chip includes a two-dimensional photonic integrated quantum walk structure; the two-dimensional photonic integrated quantum walk structure includes a cladding 2 and at least two waveguide layers stacked in a thickness direction. Each of the waveguide layers includes at least two waveguides 1, and the cladding 2 wraps the waveguides 1. The waveguides 1 are parallel to each other, and arranged in a matrix on a plane perpendicular to an extension direction of the waveguides 1. Any one of the waveguides 1 is coupled with the waveguides 1 in a row direction, a column direction and a diagonal direction.

The two-dimensional photonic integrated quantum walk structure is used for a two-dimensional optical quantum walk model, i.e., the quantum walk phenomenon is realized based on the two-dimensional photonic integrated quantum walk structure. In this embodiment, the two-dimensional photonic integrated quantum walk structure can be provided with the waveguides 1 arranged on an array. Specifically, at least two waveguide layers stacked in the thickness direction can be provided, and each of the waveguide layers includes at least two waveguides 1. In addition, either the waveguides 1 in the same layer or the waveguides 1 in different layers can be parallel to each other. One waveguide layer is provided with a plurality of waveguides 1, corresponding to arranging a plurality of waveguides 1 in a row direction, and stacking a plurality of the waveguide layers corresponds to arranging a plurality of waveguides 1 in a column direction. In this embodiment, the waveguides 1 of two adjacent waveguide layers can be aligned with each other, so that the waveguides 1 can be arranged in a matrix on a plane perpendicular to an extension direction of the waveguides 1. For example, when a total of two waveguide layers are provided and each of the waveguide layers is provided with two waveguides 1, a waveguide array with a 2×2 matrix arrangement can be formed. Thus, any one of the waveguides 1 in the waveguide array is coupled with the waveguides 1 in the row direction, the column direction, and the diagonal direction, such that one waveguide 1 is coupled with at least three waveguides 1 in the waveguide array with matrix arrangement. Thus, when the waveguide array is expanded, the waveguides 1 can be coupled to a greater number of waveguides 1. Mutually coupled waveguides 1 allow photons to jump from one waveguide 1 to another coupled waveguide 1 during quantum walk.

In this embodiment, the two-dimensional photonic integrated quantum walk structure further includes a cladding 2, and the cladding 2 wraps each of the waveguides 1, such that photons can be transmitted in any one of the waveguides 1. The material of the waveguide 1 and the cladding 2 can be referred to the prior art, and will not be described in detail herein. The cladding 2 and the waveguides 1 are provided on the surface of a substrate 3, and the material of the substrate 3 can be set based on actual conditions, which is not limited herein.

Specifically, in this embodiment, the two-dimensional photonic integrated quantum walk structure includes at least three waveguide layers, and each of the waveguide layers includes at least three waveguides 1 arranged at equal intervals. In each of the waveguide layers, the waveguides 1 arranged at equal intervals can form a regularly arranged waveguide array. In this embodiment, the cross-section of one waveguide 1 perpendicular to the extension direction can be circular or rectangular, depending on the specific situations. As an example of a rectangular waveguide 1, the thickness of the waveguide 1 can be h; the width of the waveguide 1 can be w; the spacing between adjacent waveguides 1 in the same layer can be g; and the spacing between adjacent waveguides 1 in the same column can be d.

In combination with the above description, a waveguide array of at least 3×3 can be formed in this embodiment. Thus, the waveguide 1 disposed at the center can be coupled with a total of eight waveguides 1 in a row direction, a column direction, and a diagonal direction. The waveguide 1 disposed in the corner can be coupled with a total of three waveguides 1 in a row direction, a column direction, and a diagonal direction; and the waveguide 1 disposed at the side can be coupled with a total of five waveguides 1 in a row direction, a column direction, and a diagonal direction. With the expansion of the waveguide array, the waveguide 1 coupled with five waveguides 1 at the side and the waveguide 1 coupled with eight waveguides 1 at the center can be further increased.

In this embodiment, one of the waveguides 1 coupled with the other eight waveguides 1 is an input waveguide 1, i.e., the waveguide 1 at the center of the waveguide array is selected as an input waveguide 1. The input waveguide 1 is a waveguide 1 for inputting photons. Since the input waveguide 1 is coupled with the other eight waveguides 1, the quantum walk effect can be fully reflected in a two-dimensional plane, i.e., a plane perpendicular to an extension direction of the waveguide 1, and a two-dimensional optical quantum walk model is realized. Certainly, in this embodiment, other waveguides 1 can also be selected as an input waveguide 1, which depends on the specific situations and is not specifically limited herein.

The embodiments of the disclosure provide a two-dimensional photonic integrated quantum walk chip. By arranging a plurality of waveguide layers and arranging at least two waveguides 1 in each of the waveguide layers, a waveguide array in matrix arrangement can be formed, and any one of the waveguides 1 is coupled with the waveguides 1 in a row direction, a column direction and a diagonal direction, so that after one waveguide 1 receives photons, a two-dimensional optical quantum walk model in a plane can be realized based on the coupling relationship.

The specific structure of the two-dimensional photonic integrated quantum walk chip provided by the disclosure can be described in detail in the following embodiments of the disclosure.

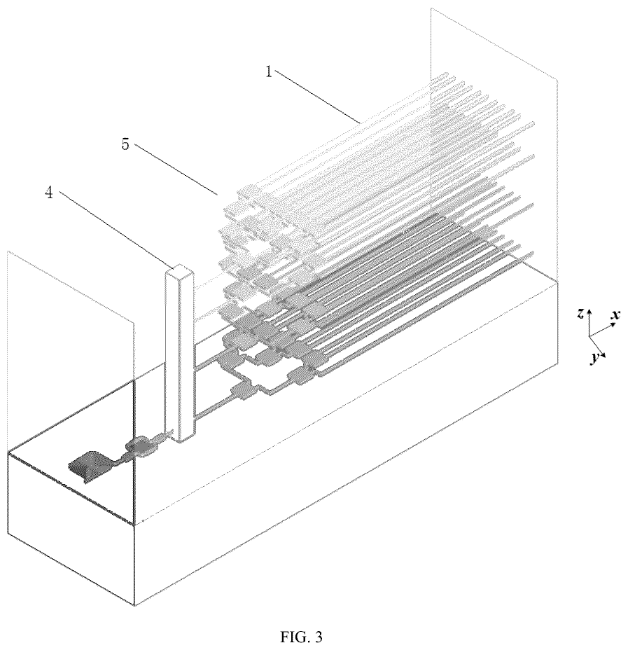

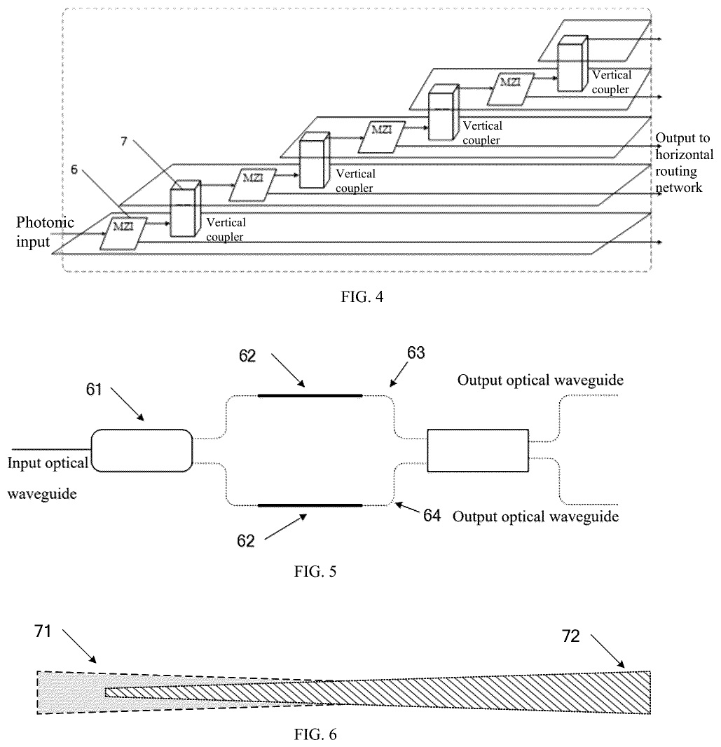

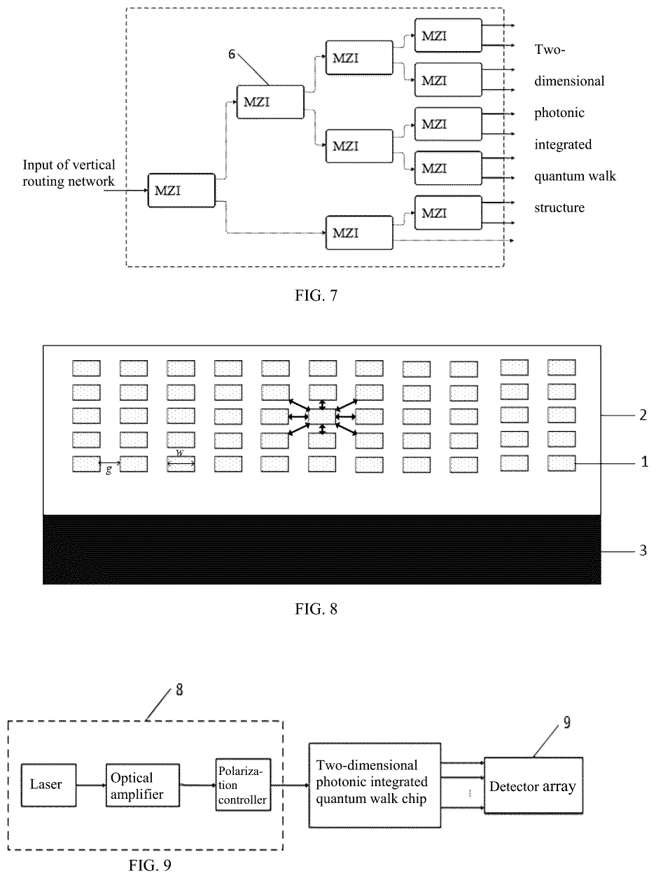

Referring to FIG. 3, FIG. 3 is a structure schematic diagram of a two-dimensional photonic integrated quantum walk chip based on an embodiment of the disclosure; FIG. 4 is a structure schematic diagram of a vertical routing network in FIG. 3; FIG. 5 is a structure schematic diagram of a Mach-Zehnder interferometer in FIG. 4; FIG. 6 is a structure schematic diagram of a top view of a vertical coupler in FIG. 4; FIG. 7 is a structure schematic diagram of a horizontal routing network in FIG. 3; and FIG. 8 is a coupling schematic diagram of a yz cross section of a two-dimensional photonic integrated quantum walk structure based on an embodiment of the disclosure.

Different from the above embodiments, the embodiments of the disclosure further define the structure of the two-dimensional photonic integrated quantum walk chip on the basis of the above embodiments. Regarding the rest of contents, please refer to the above embodiments of the disclosure for details, and it can not be repeated herein.

Referring to FIG. 3, in the embodiment of the disclosure, the two-dimensional photonic integrated quantum walk chip further includes a light source and an optical routing network, wherein the light source is connected to an input end of the optical routing network, and an output end of the optical routing network is connected to an input end of a corresponding waveguide 1.

The light source, the optical routing network and the two-dimensional photonic integrated quantum walk structure can be integrated in the same two-dimensional photonic integrated quantum walk chip, so that they can share the same substrate 3. The light source is a single photon source, which can emit a single photon to the two-dimensional photonic integrated quantum walk structure, and the single photon is a pulse light to simulate a single photon quantum walk. Certainly, the light source can be a continuous light source to achieve statistics of quantum walks and the like. The structure of the light source is not specifically limited in the embodiments of the disclosure, and can be determined based on the specific situations. When a single photon source is used, the single photon source consists of a single photon generator and a filter, and the single photon source can be formed by a single photon generator including a micro-ring resonator or a spiral optical waveguide and a filter including a micro-ring resonator or an unequal-armed Mach-Zehnder interferometer.

The optical routing network is a transmission structure between a light source and a two-dimensional photonic integrated quantum walk structure, which is mainly used for transmitting photons output by the light source to the corresponding waveguide 1. Therefore, the light source can be connected to an input end of the optical routing network which has a plurality of output ends, and an output end of the optical routing network can be connected to an input end of the corresponding waveguide 1. Generally, an output end of the optical routing network can be connected one-to-one with the waveguide 1 in the two-dimensional photon integration quantum walk structure. Certainly, an output end of the optical routing network can only be connected to some of the waveguides 1, such as the waveguides 1 disposed in the center, in the two-dimensional photon integration quantum walk structure, so as to transmit photons to the corresponding waveguides 1, thereby realizing quantum walk.

Specifically, the optical routing network includes a vertical routing network 4 and a multilayer horizontal routing network 5 stacked in a thickness direction. An output end of the horizontal routing network 5 is connected to an input end of a corresponding waveguide 1 in the waveguide layer, and an input end of the horizontal routing network 5 is optically connected to an output end of the vertical routing network 4.

Since the two-dimensional photonic integrated quantum walk structure in this embodiment is a multi-layer structure, the corresponding optical routing network can also allow photons moving in the row direction and in the column direction, so that the photons can be transmitted to the corresponding waveguide 1. Thus, the optical routing network can include a vertical routing network 4 and a multilayer horizontal routing network 5 stacked in a thickness direction, wherein the vertical routing network 4 can allow the photons moving in the column direction and the horizontal routing network 5 can allow the photons moving in the row direction. In this embodiment, the horizontal routing network 5 is stacked in a thickness direction, an input end of the horizontal routing network 5 can be optically connected to an output end of the vertical routing network 4, and an output end of the horizontal routing network 5 can be connected to an input end of the corresponding waveguide 1. That is, in this embodiment, photons are first input into the vertical routing network 4, and transmitted through the vertical routing network 4 to the layer where the input waveguide 1 is located, and then photons are transmitted to the input waveguide 1 through the horizontal routing network 5 of the layer.

Referring to FIG. 4, in order to achieve the above functions, in this embodiment, the vertical routing network 4 includes a multi-stage Mach-Zehnder interferometer 6 corresponding one-to-one with the horizontal routing network 5, and a vertical coupler 7 disposed between adjacent horizontal routing networks 5; in the vertical routing network 4, an input end of the vertical coupler 7 is coupled to an output end of one Mach-Zehnder interferometer 6, and an output end of the vertical coupler 7 is coupled to an input end of the Mach-Zehnder interferometer 6 in another adjacent layer.

Referring to FIG. 5, the Mach-Zehnder interferometer (MZI) 6 includes two output ends, which can transmit the input photons directionally to one output end, to control the transmission path of photons. The Mach-Zehnder interferometer 6 can include an input optical waveguide, a 50:50 beam splitter 61, a first interference arm 63, a second interference arm 64, a shifter phase 62, and an output optical waveguide, wherein the 50:50 beam splitter 61 can be a multimode interferometer, a directional coupler, or a Y-waveguide structure; the shifter phase 62 can be a thermo-optical shifter phase 62, an electro-optical shifter phase 62, a phase-change material shifter phase 62, etc., and the shifter phase 62 can be provided in the first interference arm 63 and the second interference arm 64, or the shifter phase 62 can be provided only in any of the interference arms, which is not specifically limited herein.

Referring to FIG. 6, in this embodiment, the vertical coupler 7 includes a first tapered waveguide 71 disposed in one layer and a second tapered waveguide 72 disposed in another adjacent layer; the first tapered waveguide 71 is coupled to the second tapered waveguide 72 by reverse stacked coupling. The vertical coupler 7 is formed of two tapered waveguides by the stacked coupling in the thickness direction, and the so-called tapered waveguide means that the width of one end of the tapered waveguide is greater than that of the other end of the tapered waveguide. In this embodiment, the first tapered waveguide 71 and the second tapered waveguide 72 can be parallel to each other, but can be coupled by reverse stacked coupling. That is, an end portion of the first tapered waveguide 71 with a smaller width can be provided opposite to an end portion of the second tapered waveguide 72 with a larger width, and an end portion of the first tapered waveguide 71 with a larger width can be provided opposite to an end portion of the second tapered waveguide 72 with a smaller width. In this way, photons can be transmitted between different layers in the vertical routing network 4 via the vertical coupler 7 with the above structure.

In a vertical routing network 4, an input end of the vertical coupler 7 is coupled to an output end of one Mach-Zehnder interferometer 6, and an output end of the vertical coupler 7 is coupled to an input end of the Mach-Zehnder interferometer 6 in another adjacent layer. Thus, the other output end of the Mach-Zehnder interferometer 6 can be connected to the input end of the corresponding horizontal routing network 5, and through the Mach-Zehnder interferometer 6, it can be determined whether the input photons can be transmitted to the adjacent layer through the vertical coupler 7. After transmitted to the target layer, the photons can be transmitted to the horizontal routing network 5 through the Mach-Zehnder interferometer 6, to be transmitted to the corresponding waveguide 1 via the corresponding horizontal routing network 5.

Preferably, in this embodiment, an input end of the Mach-Zehnder interferometer 6 disposed at the lowermost layer or the uppermost layer of the vertical routing network 4 is optically connected to an output end of the light source. Thus, only one vertical coupler 7 can be disposed between two horizontal routing networks 5 in adjacent layers, which enables the photons to move in the vertical routing network 4 along a direction from bottom to top or from top to bottom.

Referring to FIG. 7, in this embodiment, the horizontal routing network 5 is provided with a multi-stage Mach-Zehnder interferometer 6 arranged in a tree structure to form a plurality of optical paths; an input end of the horizontal routing network 5 is optically connected to an output end of a corresponding Mach-Zehnder interferometer 6 in the vertical routing network 4. That is, in this embodiment, the horizontal routing network 5 is also formed using the Mach-Zehnder interferometer 6, and specifically, using a multi-stage Mach-Zehnder interferometer 6 arranged in a tree structure to form a multi-stage structure, so that photons received by the Mach-Zehnder interferometer 6 in the vertical routing network 4 are transmitted directionally to the final target waveguide 1.

Referring to the horizontal routing network 5 provided in FIG. 7, it can transmit single photon from the vertical routing network 4 to an input port of the two-dimensional photonic integrated quantum walk structure corresponding to the waveguide layer. The horizontal routing optical network is 1×11 in FIG. 7 and can be routed to at most 11 input ports. The number N of output ports in the horizontal routing optical network is more than or equal to 2. In this embodiment, each waveguide layer is connected to a corresponding horizontal routing network 5. The horizontal routing network 5 inputs single photon to a certain input port of the optical quantum walk computing structure in the waveguide layer.

FIG. 8 is a coupling schematic diagram of a yz cross section of a two-dimensional photonic integrated quantum walk structure based on an embodiment of the disclosure. The number of waveguide layers in the two-dimensional photonic integrated quantum walk structure is 5, and the number of waveguides 1 in each layer is 11 in FIG. 8. The width of the waveguide 1 is w and the gap between the waveguides 1 is g. Referring to FIG. 8, the waveguide 1 in the central region is described as an example, and the waveguide 1 can be coupled to eight adjacent optical waveguides 1.

The embodiment of the disclosure provides a two-dimensional photonic integrated quantum walk chip. The photons generated by the light source can be transmitted through the optical routing network to the corresponding waveguide 1, realizing simulation of the two-dimensional optical quantum walk.

Referring to FIG. 9, FIG. 9 is a structure schematic diagram of a two-dimensional photonic integrated quantum walk system based on an embodiment of the disclosure.

The disclosure further provides a two-dimensional photonic integrated quantum walk system, including a laser emitting device 8, a detector array 9 and the two-dimensional photonic integrated quantum walk chip based on any one of the above steps, wherein the laser emitting device 8 can emit laser to the two-dimensional photonic integrated quantum walk chip and the detector array 9 can obtain optical signals output by the two-dimensional photonic integrated quantum walk chip.

The laser emitting device 8 includes a laser, an optical amplifier and a polarization controller disposed along an optical path, wherein the laser passing through the polarization controller is input into the light source to form desired photons, and the photon is transmitted to the corresponding waveguide 1 in the two-dimensional photonic integrated quantum walk structure through an optical routing network to realize the two-dimensional optical quantum walk. The detector array 9 detects the signal generated by the quantum walk to obtain the calculation result of the quantum walk.

The specific steps of the quantum walk experiment process based on the above two-dimensional photonic integrated quantum walk chip in this embodiment are as follows:
Step 1: amplifying a laser with a wavelength of 1550 nm through an optical amplifier, and then coupling and inputting the laser into a two-dimensional photonic integrated chip through a polarization controller.
Step 2: generating a single photon source after the input light passes through an on-chip integrated single photon source structure, and then injecting it into a certain waveguide 1 of the two-dimensional photonic integrated quantum walk chip.
Step 3: detecting the output light by a superconducting nanowire single photon detector array 9 serving as a detector array 9 after the output light from the waveguide 1 in the two-dimensional photonic integrated quantum walk chip is output by coupling.
Step 4: analyzing the probability distribution of a discrete quantum walk at different positions by analyzing the output light intensity of the waveguide 1 at different positions, to obtain the calculation result of the discrete quantum walk.

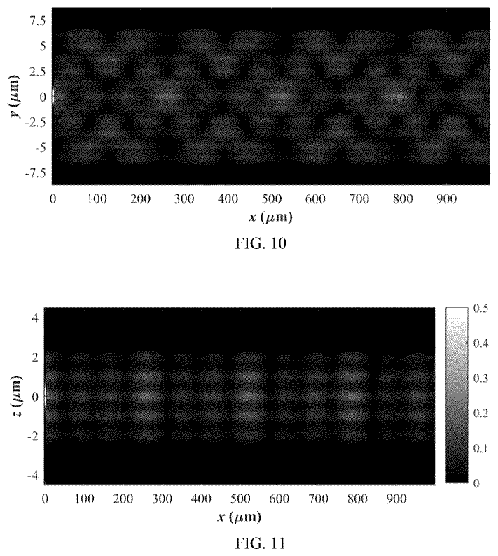

FIG. 10 is a schematic diagram of optical transmission of an xy cross-section of simulation results of the two-dimensional optical quantum walk chip based on an embodiment of the disclosure; and FIG. 11 is a schematic diagram of optical transmission of an xz cross-section of simulation results of the two-dimensional optical quantum walk computing chip based on an embodiment of the disclosure. In the simulation results, there are 5 silicon nitride multilayer waveguide layers of the two-dimensional photonic integrated quantum walk structure, and there are 11 parallel waveguides 1 in each layer of waveguide layers. The width w of all the waveguides 1 is 1 μm; the thickness h of the waveguides 1 is 450 nm; the gap g between the waveguides 1 in the horizontal direction is 222 nm; the gap d between the waveguides 1 in the vertical direction is 500 nm; and the length of optical path is 1 mm.

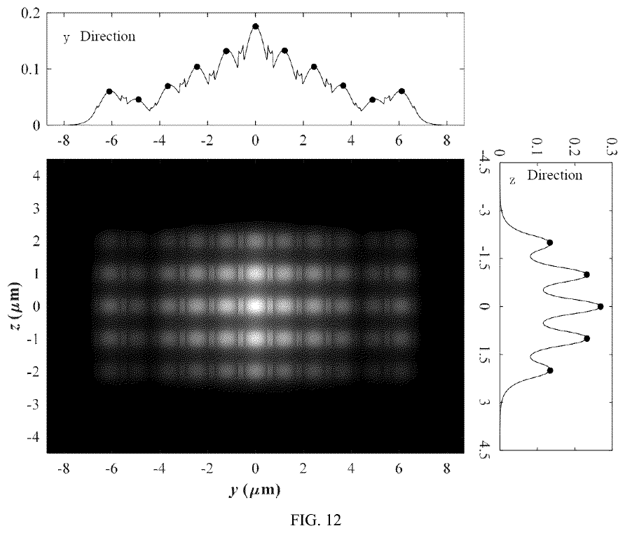

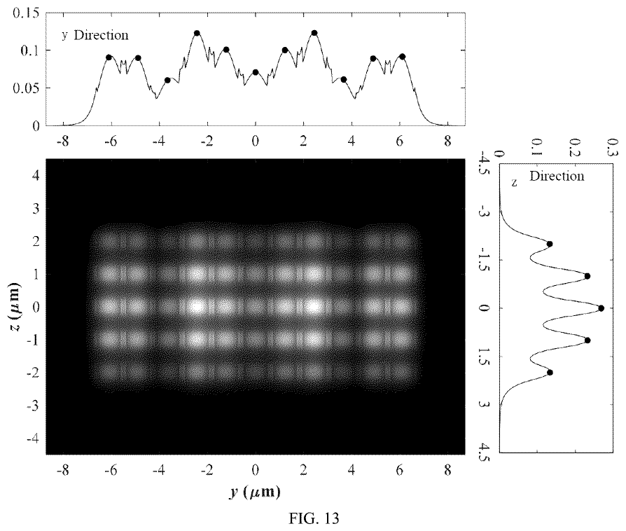

FIG. 12 shows simulation results of light field distribution of a yz cross-section and probability distribution projected in each direction after a single photon propagates 500 μm in the optical quantum walk structure in the two-dimensional photonic integrated quantum walk chip based on an embodiment of the disclosure; and FIG. 13 shows simulation results of light field distribution of a yz cross-section and probability distribution projected in each direction after a single photon propagates 1 mm in the optical quantum walk structure in the two-dimensional optical quantum walk chip based on an embodiment of the disclosure. The two-dimensional optical quantum walk chip shown in this embodiment can not only be used to simulate a continuous quantum walk model, but also realize a discrete quantum walk model through discretization processing by collecting light field output intensities of different waveguides 1.

The two-dimensional photonic integrated quantum walk chip structure provided in the embodiments of the disclosure has the advantages of high integration, compatibility with CMOS (Complementary Metal Oxide Semiconductor) process, and low cost.

Each embodiment in the specification is described in a progressive manner, each embodiment focuses on the differences from other embodiments, and the same or similar parts among the embodiments can be referred to each other.

Those skilled in the art can further realize that the units and algorithmic steps of the examples described in conjunction with the embodiments disclosed herein can be implemented in electronic hardware, computer software, or a combination thereof. To clearly illustrate the interchangeability of hardware and software, the components and steps of the examples have been described generally in terms of function in the above description. Whether these functions are performed in hardware or software depends on the particular application and design constraints of the technical solution. Those skilled in the art can use different methods to implement the described functions for each particular application, but such implementations should not be considered as going beyond the scope of the disclosure.

The steps of the methods or algorithms described in conjunction with the embodiments disclosed herein can be implemented directly with hardware, a software module executed by a processor, or a combination thereof. A software module can be placed in random access memory (RAM), memory, read-only memory (ROM), electrically programmable ROM, electrically erasable programmable ROM, a register, a hard disk, a removable diskette, a CD-ROM, or any other form of storage medium known in the art.

Finally, it should also be noted that relationship terms such as first and second, etc. are used herein only to distinguish one entity or operation from another without necessarily requiring or implying any such actual relationship or order between those entities or operations. Moreover, the terms “comprise”, “include” or any other variation thereof, are intended to cover a non-exclusive inclusion, such that a process, a method, an article, or an apparatus comprising a list of elements includes not only those elements, but also other elements not explicitly listed or can include elements inherent to the process, method, article, or apparatus. Without further limitation, an element defined by the statement of “comprising a . . . ” does not exclude the further presence of additionally identical elements in a process, a method, an article or an apparatus comprising said element.

A two-dimensional photonic integrated quantum walk chip and a two-dimensional photonic integrated quantum walk system are described in detail in the disclosure. Specific examples are used herein to illustrate the principles and embodiments of the disclosure, and the above description of the examples is merely intended to aid in the understanding of the methods of the disclosure and the core concepts thereof. It should be noted that those skilled in the art can make several modifications and variations to the disclosure without departing from the principles of the disclosure, and these modifications and variations also fall within the protection scope of the claims of the disclosure.

What is claimed is:

1. A two-dimensional photonic integrated quantum walk chip, comprising a two-dimensional photonic integrated quantum walk structure;
the two-dimensional photonic integrated quantum walk structure comprises a cladding and at least two waveguide layers stacked in a thickness direction, each of the waveguide layers comprising at least two waveguides, the cladding wrapping the waveguides;
the waveguides are parallel to each other, and arranged in a matrix on a plane perpendicular to an extension direction of the waveguides; any one of the waveguides is coupled with the waveguides in a row direction, a column direction and a diagonal direction.

2. The two-dimensional photonic integrated quantum walk chip of claim 1, wherein the two-dimensional photonic integrated quantum walk structure comprises at least three waveguide layers, each of the waveguide layers comprising at least three waveguides arranged at equal intervals.

3. The two-dimensional photonic integrated quantum walk chip of claim 2, wherein one of the waveguides coupled with the other eight waveguides is an input waveguide.

4. The two-dimensional photonic integrated quantum walk chip of claim 1, wherein the two-dimensional photonic integrated quantum walk chip further comprises a light source and an optical routing network, wherein the light source is connected to an input end of the optical routing network, and an output end of the optical routing network is connected to an input end of a corresponding waveguide.

5. The two-dimensional photonic integrated quantum walk chip of claim 4, wherein the optical routing network comprises a vertical routing network and a multilayer horizontal routing network stacked in the thickness direction, an output end of the horizontal routing network being connected to an input end of a corresponding waveguide in the waveguide layer;
an input end of the horizontal routing network is optically connected to an output end of the vertical routing network.

6. The two-dimensional photonic integrated quantum walk chip of claim 5, wherein the vertical routing network comprises a multi-stage Mach-Zehnder interferometer corresponding one-to-one with the horizontal routing network, and a vertical coupler disposed between adjacent horizontal routing networks;
in a vertical routing network, an input end of the vertical coupler is coupled to an output end of the Mach-Zehnder interferometer, and an output end of the vertical coupler is coupled to an input end of the Mach-Zehnder interferometer in another adjacent layer.

7. The two-dimensional photonic integrated quantum walk chip of claim 6, wherein an input end of the Mach-Zehnder interferometer disposed at the lowermost layer or the uppermost layer of the vertical routing network is optically connected to an output end of the light source.

8. The two-dimensional photonic integrated quantum walk chip of claim 6, wherein the vertical coupler comprises a first tapered waveguide disposed in one layer and a second tapered waveguide disposed in another adjacent layer; the first tapered waveguide is coupled to the second tapered waveguide by reverse stacked coupling.

9. The two-dimensional photonic integrated quantum walk chip of claim 5, wherein the horizontal routing network is provided with a multi-stage Mach-Zehnder interferometer arranged in a tree structure to form a plurality of optical paths;
the input end of the horizontal routing network is optically connected to an output end of a corresponding Mach-Zehnder interferometer in the vertical routing network.

10. A two-dimensional photonic integrated quantum walk system, comprising a laser emitting device, a detector array and the two-dimensional photonic integrated quantum walk chip of any one of claim 1, wherein the laser emitting device is configured to emit laser to the two-dimensional photonic integrated quantum walk chip and the detector array is configured to obtain optical signals output by the two-dimensional photonic integrated quantum walk chip.
